(19) United States
(12) Patent Application Publication
(10) Pub. No.: US 2014/0141158 A1
(43) Pub. Date: May 22, 2014

(54) POWDER DEPOSITION APPARATUS AND POWDER DEPOSITION METHOD

(71) Applicant: Sony Corporation, Tokyo (JP)

(72) Inventors: Go Sudo, Kanagawa (JP); Kenji Katori, Kanagawa (JP); Hayato Hommura, Kanagawa (JP)

(73) Assignee: Sony Corporation, Tokyo (JP)

(21) Appl. No.: 14/073,339

(22) Filed: Nov. 6, 2013

(30) Foreign Application Priority Data
Nov. 20, 2012 (JP) 2012-253868

(51) Int. Cl. B05C 7/02; B05D 1/00

(52) U.S. Cl. CPC B05C 7/02; B05D 1/002
USPC 427/183; 118/50

(57) ABSTRACT

There is provided a powder deposition apparatus including a drum-like rotating body disposed in a vacuum container and configured to rotate in a vertical direction, a deposition source disposed inside the drum-like rotating body, a tubular powder supplying/recovering member disposed close to an inner wall of the drum-like rotating body and configured to recover powder coming through an upper face and to supply the powder to the inner wall through a lower face, and a lid member provided in a vicinity of the lower face of the powder supplying/recovering member and configured to supply the powder to the inner wall through the lower face of the powder supplying/recovering member by being allowed in an open state and to accumulate the powder coming in the powder supplying/recovering member through the upper face by being allowed in a closed state.

### CROSS REFERENCE TO RELATED APPLICATIONS

This application claims the benefit of Japanese Priority Patent Application JP 2012-253868 filed Nov. 20, 2012, the entire content of which is incorporated herein by reference.

### BACKGROUND

The present disclosure relates to a powder deposition apparatus performing deposition on the surfaces of powder and a powder deposition method of performing deposition on the surfaces of powder.

Performing deposition is proposed when attaching some substance on the surfaces of powder. When performing deposition a material to be formed into a coating film is vaporized due to heating or the like and the vaporized material is allowed to collide with the surfaces of powder. Thus, the coating films are formed on the surfaces of the powder.

Typically, deposition on the surfaces of powder has been expecting a deposition apparatus that has a complex configuration. Namely, since the deposition can only be performed upward the particles are expected to be placed upward of a deposition source. Due to this, it has been typically proposed that the powder is contained in a cylindrical container rotating fast and that a deposition source disposed in the cylindrical container performs the deposition. Rotating the cylindrical container fast enables the powder to pass through the upper portion inside the cylindrical container due to centrifugal force. Then, a material vaporized from the deposition source reaches the powder in its passing through the upper portion inside the cylindrical container, and thereby, coating films are formed on the surfaces of the powder.

Japanese Patent Laid-Open No. 2008-045197 discloses a configuration for performing deposition on powder using such a cylindrical container.

### SUMMARY

When performing deposition on powder using the cylindrical container as mentioned above, there is a problem that supply operation of the powder to the cylindrical container and recovery operation of the powder after the deposition are difficult. Namely, in order to allow the powder to be uniformly dispersed on the inner face of the cylindrical container, first, the cylindrical container is rotated horizontally to apply centrifugal force such that the powder sticks to the annular inner face of the cylindrical container. Then, maintaining the rotation, the cylindrical container is brought to the upright position vertically, and upon this, the deposition is performed in the cylindrical container using a deposition source.

Otherwise, rotating the cylindrical container which is maintained in the upright state at a sufficiently high speed, the powder is supplied to the inside of the cylindrical container to perform the deposition.

However, in any of these methods, there is a problem that the apparatus expects a complex configuration. For example, when the cylindrical container is moved from the horizontal state to the vertical state, room available for moving the cylindrical container is expected in a vacuum container, this expecting a vacuum container exceedingly large in dimensions. Moreover, in case of supplying powder in a cylindrical container which is disposed in a vacuum space and rotates fast, an exceedingly complex powder supplying mechanism is expected to be disposed in the vacuum container.

Furthermore, in any of these configurations, there is a problem that workability of operation of recovering the powder from the inside of the cylindrical container after the end of the deposition is poor. For example, there are expected opening the cylindrical container taken out of the vacuum container after the end of the deposition and sucking the powder scattering in the container with a sucking apparatus to recover it. There is a problem that such recovery operation is poor at workability, being exceedingly tedious operation.

It is desirable to provide a powder deposition apparatus and a powder deposition method capable of performing deposition on powder efficiently.

A powder deposition apparatus according to an embodiment of the present disclosure includes: a drum-like rotating body disposed in a vacuum container and configured to rotate in a vertical direction; a deposition source disposed inside the drum-like rotating body; a tubular powder supplying/recovering member; and a lid member provided in a vicinity of a lower face of the powder supplying/recovering member.

The tubular powder supplying/recovering member is disposed close to an inner wall of the drum-like rotating body and configured to supply powder to the inner wall through a lower face while recovering the powder coming through an upper face.

The lid member is configured to supply the powder to the inner wall through the lower face of the powder supplying/recovering member by being allowed in an open state and to accumulate the powder coming in the powder supplying/recovering member through the upper face by being allowed in a closed state.

Moreover, a powder deposition method according to an embodiment of the present disclosure includes: (1) disposing, in a vacuum container, a drum-like rotating body configured to rotate in a vertical direction; (2) disposing a deposition source inside the drum-like rotating body; (3) performing, after powder is supplied to an inner wall of the drum-like rotating body in a state where the drum-like rotating body rotates, a bottom portion of a tubular powder supplying/recovering member allowed in an open state, deposition by the deposition source; (4) recovering the powder supplied to the inner wall of the drum-like rotating body through an upper face of the tubular powder supplying/recovering member; and (5) accumulating the recovered powder in the tubular powder supplying/recovering member by allowing a vicinity of a lower face of the tubular powder supplying/recovering member in a closed state.

According to the present disclosure, using a tubular powder supplying/recovering member, supply and recovery of powder to/from a drum-like rotating body in which a deposition source is disposed can be performed in a vacuum container. Accordingly, the supply and recovery of powder can be efficiently performed in deposition on the powder.

### BRIEF DESCRIPTION OF THE DRAWINGS

FIG. 1 is a lateral view illustrating a configuration of a powder deposition apparatus as an example according to an embodiment of the present disclosure;

FIG. 2 is a perspective view illustrating the configuration of the powder deposition apparatus as the example according to the embodiment of the present disclosure;

FIG. 3 is a perspective view illustrating a lower portion of a powder supplying/recovering member included in the powder deposition apparatus as the example according to the embodiment of the present disclosure;

FIG. 4 is a flowchart illustrating a flow of deposition operation as an example according to the embodiment of the present disclosure;

FIG. 5 is an explanatory drawing of a deposition operation process (part one) as an example according to the embodiment of the present disclosure;

FIG. 6 is an explanatory drawing of a deposition operation process (part two) as the example according to the embodiment of the present disclosure;

FIG. 7 is an explanatory drawing of a deposition operation process (part three) as the example according to the embodiment of the present disclosure; and

FIG. 8 is an explanatory drawing of a deposition operation process (part four) as the example according to the embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted. The description is made in the following order.

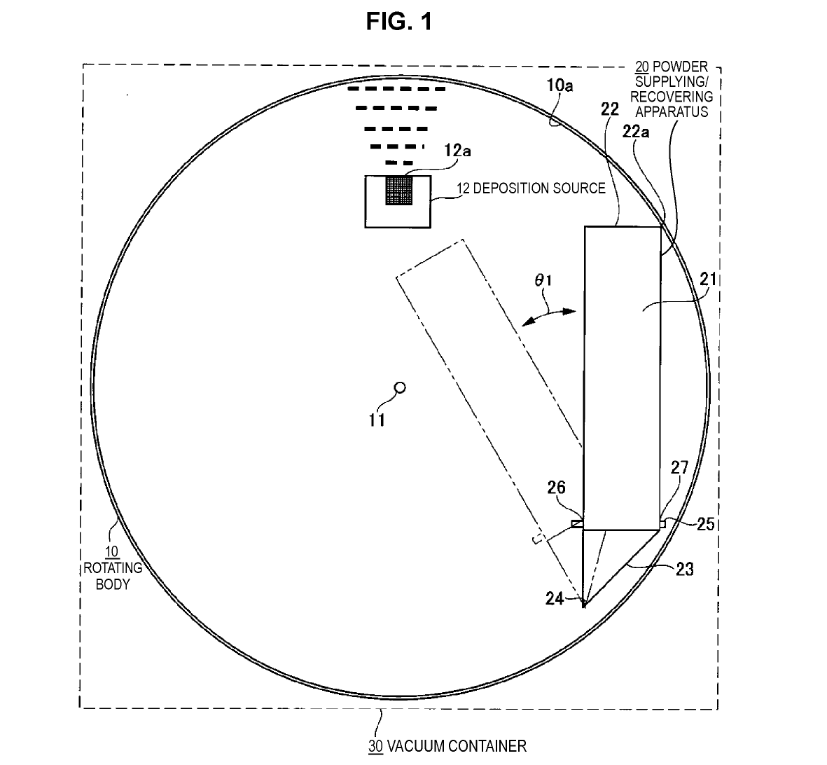

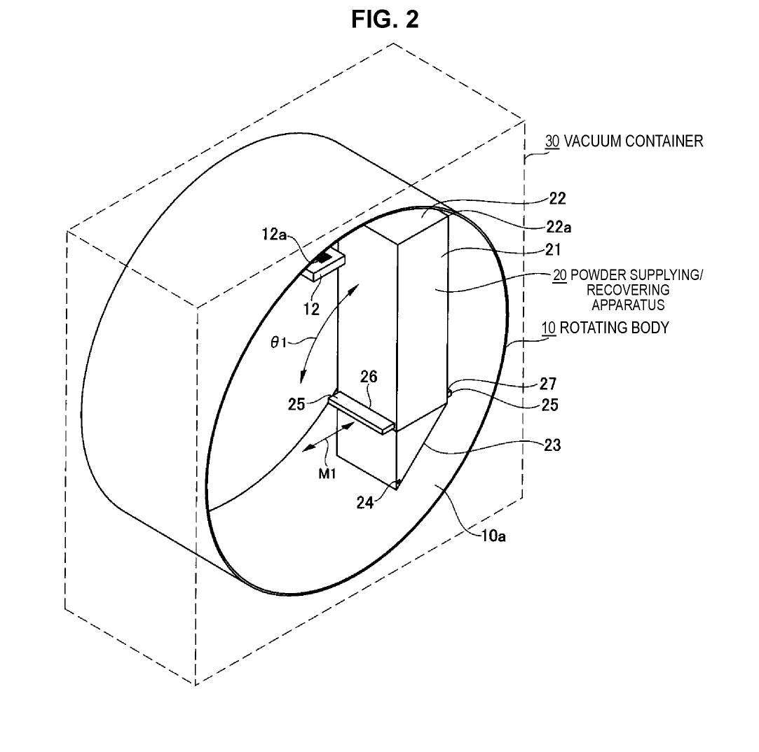

### 1. Configuration of Powder Deposition Apparatus (FIG. 1 and FIG. 2)

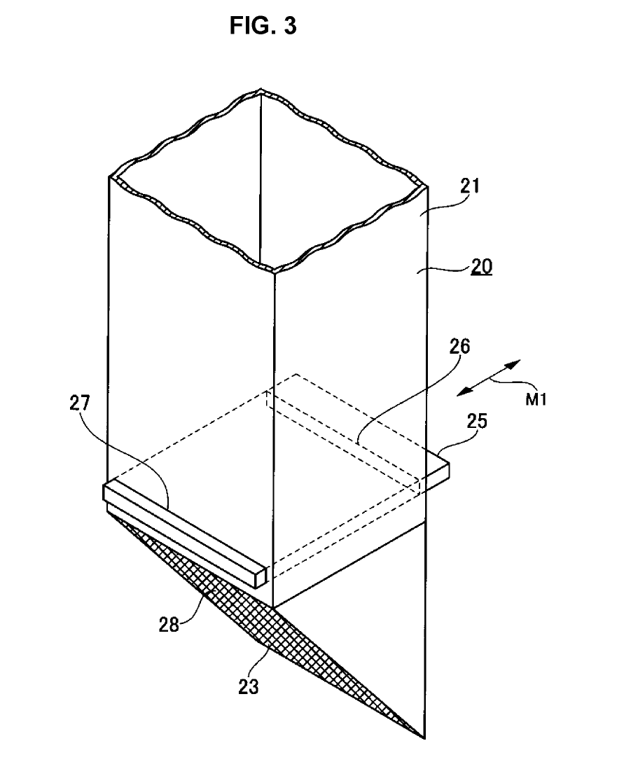

### 2. Flow of Powder Deposition Operation (FIG. 3 to FIG. 8)

### 3. Variations

[1. Configuration of Powder Deposition Apparatus]

FIG. 1 and FIG. 2 are diagrams illustrating a configuration of a powder deposition apparatus as an example according to an embodiment of the present disclosure. FIG. 1 is a lateral view thereof and FIG. 2 is a perspective view thereof.

The powder deposition apparatus includes a rotating body 10 disposed in a vacuum container 30. The vacuum container 30 only has to have a shape in which the rotating body 10 can be accommodated. The rotating body 10 is supposed to have a dimension, for example, of approximately 50 cm in diameter.

As illustrated in FIG. 1 and FIG. 2, the rotating body 10 is a drum-like rotating body and includes an inner wall 10a with a predetermined width. The rotating body 10 is not provided with a shutting member on its side face, whereas the rotating body 10 may be configured to shut its side face with a side face plate.

The rotating body 10 rotates around a rotation center axis 11. A rotation rate of the rotating body 10 is configured to be relatively high such that powder sticks to the inner wall 10a due to centrifugal force. In the figures, a driving source or a rotation mechanism performing rotation driving on the rotating body 10 is omitted.

Moreover, a deposition source 12 is disposed in an upper portion of the interior of the rotating body 10. The deposition source 12 heats and vaporizes a material of which a coating film is to be formed. Vapor generated by the vaporization in the deposition source 12 reaches an upper portion of the inner wall 10a of the rotating body 10 through an upper part 12a of the deposition source 12.

Moreover, a powder supplying/recovering apparatus 20 is disposed inside the rotating body 10. The main body of the powder supplying/recovering apparatus 20 is configured of a tubular part 21 constituted of a tubular member with a rectangular cross section. An upper face 22 and a lower face 23 of the tubular part 21 are in an open state. Moreover, the tubular part 21 is configured to have a relatively large length so as to have a function of stirring powder inside it.

The powder supplying/recovering apparatus 20 is retractable to undergo pivotal motion around a pivot fulcrum 24 at its lower end as indicated by the virtual lines in FIG. 1. Namely, the powder supplying/recovering apparatus 20 can be configured to take one of two states of an upright state of the tubular part 21 and an inclined state of the tubular part 21 due to pivotal motion θ1 around the pivot fulcrum 24.

When the powder supplying/recovering apparatus 20 is in the upright state of the tubular part 21, an edge 22a of the upper face 22 of the tubular part 21 comes into contact with the inner wall 10a of the rotating body 10. When the powder supplying/recovering apparatus 20 is in the inclined state of the tubular part 21, the edge 22a of the upper face 22 of the tubular part 21 separates from the inner wall 10a of the rotating body 10.

FIG. 3 is an enlarged view illustrating a lower portion of the tubular part 21 of the powder supplying/recovering apparatus 20. As illustrated in FIG. 3, the lower face 23 of the tubular part 21 is a slope inclined by approximately 45°. A mesh member 28 is disposed on the lower face 23 which is inclined. The mesh member 28 functions as a member stirring powder coming outside through the lower face 23 of the tubular part 21. Stirring powder using the mesh member 28 is one example and another member may stir the powder.

Moreover, two slits 26 and 27 opposite to each other are provided in the vicinity of the lower face 23 of the tubular part 21. A lower portion of the tubular part 21 is allowed in a closed state by inserting a plate-like lid member 25 through the two slits 26 and 27. The lid member 25 is horizontally moved along an arrow M1 illustrated in FIG. 2, and thereby, can be drawn out through the slit 26. A mechanism driving the lid member 25 is omitted in the figures.

Drawing the lid member 25 out through the slit 26 allows the tubular part 21 in a state where the lower portion is open and allows the powder in the tubular part 21 to be discharged into the rotating body 10 through the lower face 23. In this case, the lid member 25 can be adjusted to be in a half-open state or the like to whose extent the lower portion of the tubular part 21 is open, depending on a configuration of an amount by which it is drawn out through the slit 26. An amount of the powder to be discharged into the rotating body 10 can be adjusted depending on the extent to which the lower portion of the tubular part 21 is open.

In addition, the powder deposition apparatus includes a controlling apparatus installed outside the vacuum container 30. The controlling apparatus controls rotation of the rotating body 10, pivotal motion of the powder supplying/recovering apparatus 20 and opening and closing of the lid member 25. These controls are performed in association with deposition by the deposition source 12.

[2. Flow of Powder Deposition Operation]

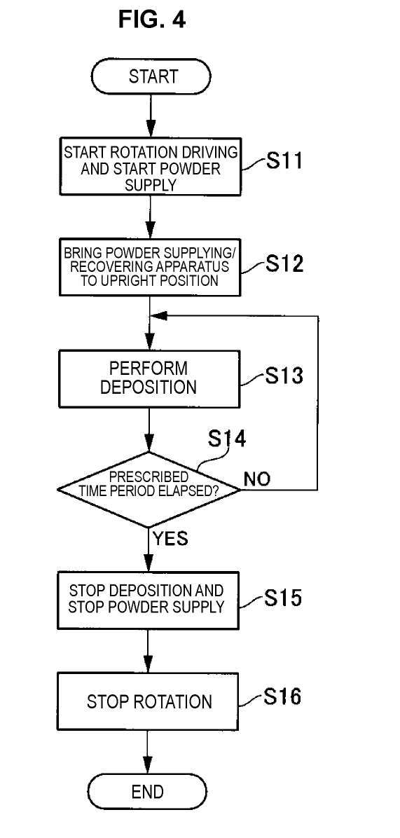

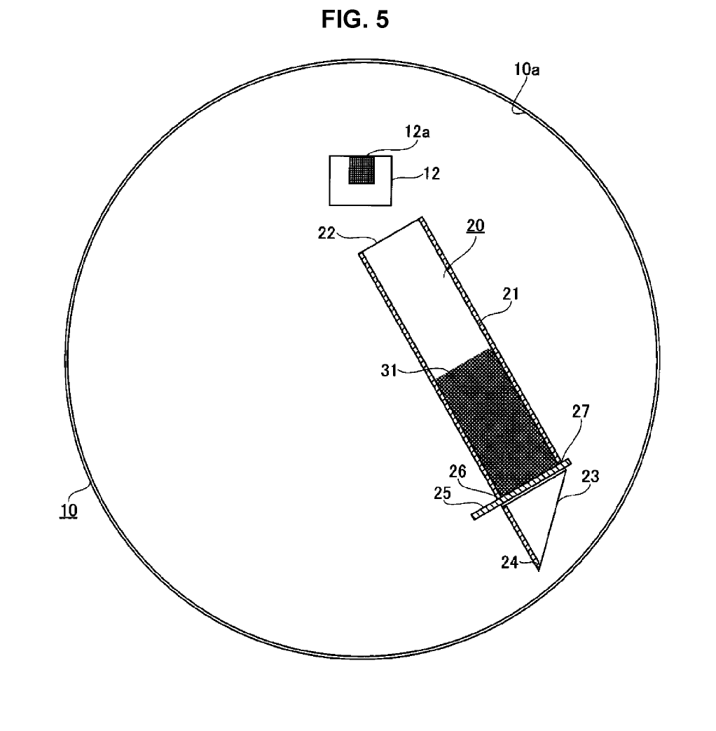

Next, a flow of processing of attaching a material to the surfaces of the powder due to deposition is described with reference to a flowchart in FIG. 4 and FIG. 5 to FIG. 8 each illustrating status in each process. In FIG. 5 to FIG. 8 each illustrating status in each process, the powder is designated by reference numeral 31. Used powder 31 is composed, for example, of fine particles made of metal or the like each of which has a diameter of approximately micrometers to tens of micrometers. Moreover, as a deposition material, for example, copper is used.

First, as illustrated in FIG. 5, the powder supplying/recovering apparatus 20 allows the lid member 25 in the state where spacing between the slits 26 and 27 is shut. The powder 31 is put into the tubular part 21 of the powder supplying/recovering apparatus 20 thus allowed in the closed state. At this stage, the tubular part 21 of the powder supplying/recovering apparatus 20 is allowed in the inclined state such that the edge 22a of the upper face 22 of the tubular part 21 is not brought into contact with the inner wall 10a of the rotating body 10.

Then, the operator starts operation of making the inside of the vacuum container 30 which is disposed in the powder supplying/recovering apparatus 20 into which the powder is thus put at a vacuum. The controlling apparatus may automatically perform the starting of the vacuum operation.

After reaching the degree of vacuum expected for deposition, the controlling apparatus rotates the rotating body 10 fast. The rotation rate at this stage is configured to be a rate to an extent to which the powder 31 sticks to the inner wall 10a of the rotating body 10 due to centrifugal force. Such a rate is a rate, for example, of approximately one hundred and tens of cycles per minute. Moreover, the rotating direction is configured to be a direction in which the powder 31 supplied through the lower face 23 of the powder supplying/recovering apparatus 20 passes the vicinity of the deposition source 12 in the upper portion to reach the upper face 22 of the powder supplying/recovering apparatus 20. In FIG. 1, such a rotating direction is a direction in which the hands of the clock rotate.

Then, in the state where the rotating body 10 thus rotates fast, the lid member 25 in the lower portion of the powder supplying/recovering apparatus 20 is drawn out through the slit 26. The drawing-out of the lid member 25 starts the supply of the powder onto the inner wall 10a through the lower face 23 of the powder supplying/recovering apparatus 20 (step S11).

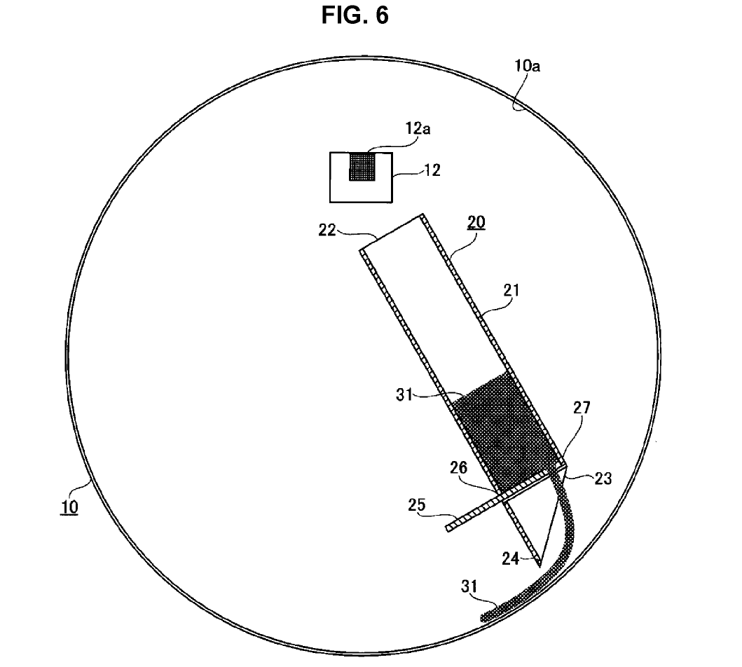

FIG. 6 is a diagram illustrating such status. In the example illustrated in FIG. 6, the lid member 25 is allowed in the half-open state by adjusting the amount by which it is drawn out through the slit 26. By doing so, the powder 31 is supplied onto the inner wall 10a portion by portion. Supplying the powder 31 as above allows the powder 31 in the state where it sticks to the inner wall 10a of the rotating body 10 rotating fast due to centrifugal force.

Then, after an amount of the powder 31 is supplied onto the inner wall 10a to some extent, the controlling apparatus allows the powder supplying/recovering apparatus 20 in the upright state (step S12). When the powder supplying/recovering apparatus 20 is allowed in the upright state, the edge 22a of the upper face 22 of the tubular part 21 comes into contact with the inner wall 10a of the rotating body 10. Upon this, the deposition source 12 starts deposition. The starting of the deposition conducts the vaporization of the deposition material (step S13).

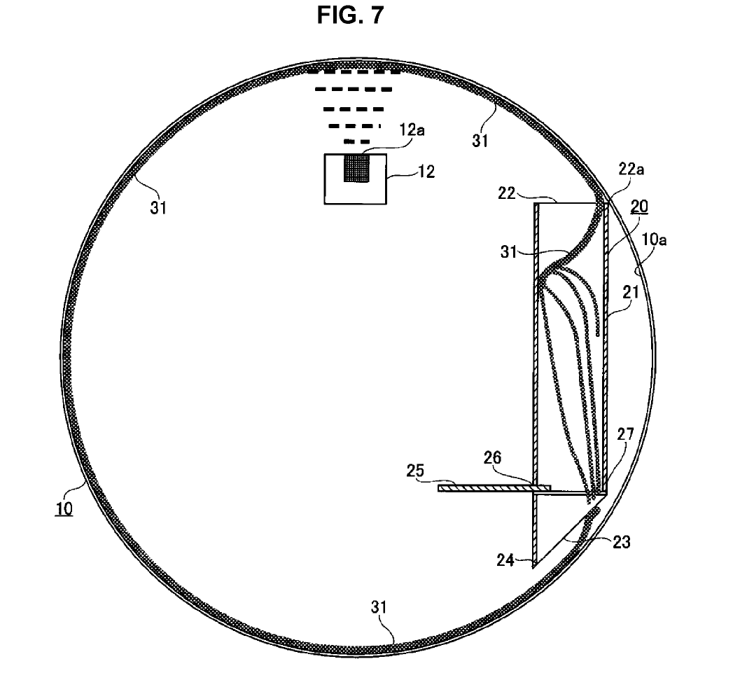

FIG. 7 is a diagram illustrating such status. As illustrated in FIG. 7, performing the deposition by the deposition source 12 allows the vaporized material to reach the powder 31 which sticks to the inner wall 10a and has reached the upper portion, films, which are made of the deposition material, formed on the surfaces of the powder 31.

Then, the rotation of the rotating body 10 allows the powder 31 having undergone the deposition to reach the portion of contact with the edge 22a of the upper face 22 of the tubular part 21. At this stage, the portion where the inner wall 10a of the rotating body 10 comes into contact with the edge 22a scratches the powder 31 off. Due to this, the powder 31 is recovered in the tubular part 21 through the upper face 22 of the powder supplying/recovering apparatus 20.

Furthermore, as illustrated in FIG. 7, after the recovered powder 31 is stirred inside the tubular part 21 which is relatively long, it is discharged onto the inner wall 10a of the rotating body 10 through the lower face 23 of the tubular part 21. Also in the discharge through the lower face 23, the powder 31 is stirred by the mesh member 28.

The operation of the state illustrated in FIG. 7 is continuously performed, and thus supply of the powder 31, deposition to the powder 31 supplied, and recovery of powder 31 deposited are repetitively performed.

Then, a controlling part determines whether or not the deposition in the status illustrated in FIG. 7 is performed for a prescribed time period or more (step S14), and the deposition in step S13 is performed until the prescribed time period elapses. The prescribed time period is configured to be relatively long, for example, approximately one hour to tens of hours. Performing the deposition continuously for the time period thus prescribed enables to perform deposition of copper on the surfaces, for example, of metal particles in approximately 10 wt %.

Then, when it is determined that the prescribed time period elapses in step S14, while the deposition source 12 is stopping the deposition, the lid member 25 in the lower portion of the powder supplying/recovering apparatus 20 is inserted through the slit 26, the lower portion allowed in the closed state (step S15). By doing so, the recovered powder 31 is accumulated in the tubular part 21 of the powder supplying/recovering apparatus 20.

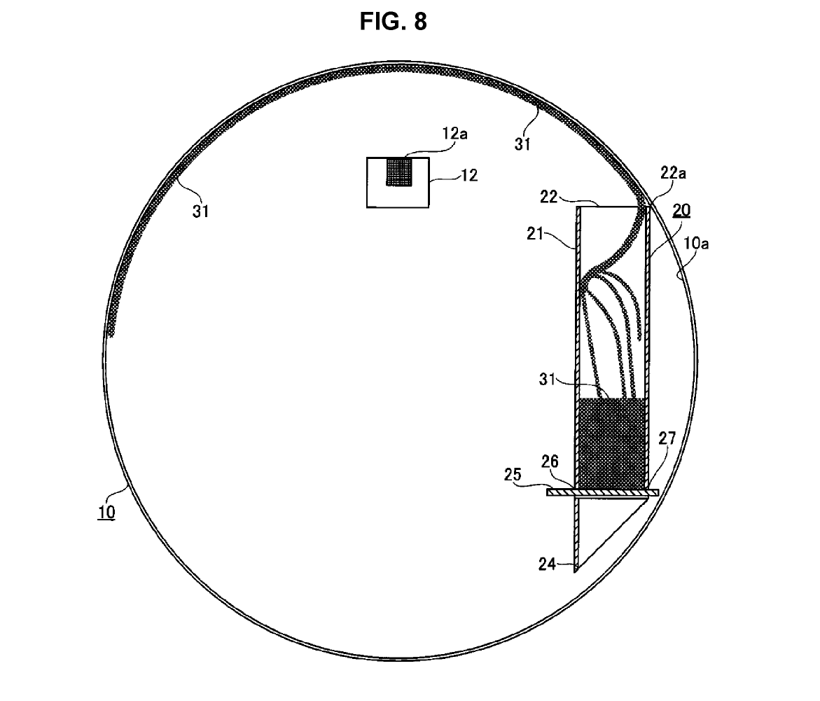

FIG. 8 is a diagram illustrating such status. As illustrating in FIG. 8, the powder 31 is being scratched off and the recovered powder 31 is being accumulated inside the tubular part 21 of the powder supplying/recovering apparatus 20.

Then, after a time period to an extent to which the powder 31 is accumulated elapses, the rotation of the rotating body 10 is stopped (step S16). After that, after the degree of vacuum in the vacuum container 30 is lowered, the vacuum container 30 is opened and the powder 31 accumulated in the powder supplying/recovering apparatus 20 is taken out.

Performing the deposition as above enables operation of attaching a deposition material to the surfaces of the powder 31 to be performed simply and exceedingly efficiently. For example, when the powder deposition apparatus illustrated in FIG. 1 was fabricated and copper was deposited on metal particles, the powder supplying/recovering apparatus 20 was able to recover 90% or more of the metal particles after the end of the deposition. Moreover, such a high recovery rate of the powder leads to effects of preventing the powder from scattering in operation and preventing contamination of the deposition source.

Furthermore, the powder supplying/recovering apparatus 20 disposed in the rotating body 10 has a relatively simple configuration, and thus, the configuration of the powder deposition apparatus can be made simple.

[3. Variations]

In addition, in the above-mentioned embodiment, when the powder supplying/recovering apparatus 20 recovers the powder, the edge 22a of the upper face 22 of the powder supplying/recovering apparatus 20 is configured to come into contact with the inner wall 10a of the rotating body 10. In place of such a contact state, the edge 22a of the upper face 22 of the powder supplying/recovering apparatus 20 may be in a state where the inner wall 10a of the rotating body 10 is close to it by a subtle gap given toward it and the powder supplying/recovering apparatus 20 may recover the powder from the inner wall 10a of the rotating body 10.

Moreover, in the above-mentioned embodiment, the mesh member 28 as a diffusion member is disposed on the lower face 23 of the powder supplying/recovering apparatus 20. On the contrary, a diffusion member with another shape may be disposed on the lower face 23 to diffuse the powder. Moreover, in place of the mesh member 28 thus disposed, when the lid member 25 is drawn out through the slit 26, a punching metal plate in which many fine openings are disposed may be inserted through the slit 26 and the punching metal plate may diffuse the powder.

Moreover, in the above-mentioned embodiment, the plate-like lid member 25 is used as a member opening and closing the lower portion of the powder supplying/recovering apparatus 20. On the contrary, another configuration may open and close the lower portion. Moreover, an opening amount in opening and closing with the lid member 25 or the like may be adjusted depending on the amount, diameter or the like of the powder used.

Moreover, in the above-mentioned embodiment, the inside of the tubular part 21 of the powder supplying/recovering apparatus 20 is configured to be a relatively long cavity, the powder stirred when the powder passes through the cavity. On the contrary, a member stirring the powder may be disposed inside the tubular part 21, positively performing the stirring.

Moreover, in the example of the above-mentioned embodiment, the example of depositing copper on the surfaces of metal particles is described, whereas a material of particles or a deposition material is one example and any combination of those may be employed as long as the material can be deposited.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) A powder deposition apparatus including:

a drum-like rotating body disposed in a vacuum container and configured to rotate in a vertical direction;

a deposition source disposed inside the drum-like rotating body;

a tubular powder supplying/recovering member disposed close to an inner wall of the drum-like rotating body and configured to recover powder coming through an upper face and to supply the powder to the inner wall through a lower face; and

a lid member provided in a vicinity of the lower face of the powder supplying/recovering member and configured to supply the powder to the inner wall through the lower face of the powder supplying/recovering member by being allowed in an open state and to accumulate the powder coming in the powder supplying/recovering member through the upper face by being allowed in a closed state.

(2) The powder deposition apparatus according to (1),

wherein the lid member supplies the powder to the inner wall under gradual change from the closed state to the open state in a state where the drum-like rotating body rotates at a rate to an extent to which centrifugal force generates such that the powder does not fall off the inner wall.

(3) The powder deposition apparatus according to (1) or (2),

wherein the powder supplying/recovering member is movable between a state where the upper face separates from the inner wall of the drum-like rotating body and a state where the upper face comes into contact with or is close to the inner wall of the drum-like rotating body,

wherein the upper face is allowed in the state where the upper face separates from the inner wall of the drum-like rotating body when the powder is supplied to the inner wall under gradual change from the closed state to the open state of the lid member, and

wherein the upper face is allowed in the state where the upper face comes into contact with or is close to the inner wall of the drum-like rotating body when the powder is recovered from the inner wall.

(4) The powder deposition apparatus according to any one of (1) to (3),

wherein, after supplying the powder to the inner wall of the drum-like rotating body through the lower face of the powder supplying/recovering member in the open state of the lid member while the powder supplying/recovering member recovers the powder from the inner wall of the drum-like rotating body, and the upper face is allowed in the state where the upper face comes into contact with or is close to the inner wall of the drum-like rotating body, the powder is accumulated in the powder supplying/recovering member, and the lid member is allowed in the closed state.

(5) The powder deposition apparatus according to any one of (1) to (4),

wherein a member configured to stir the powder is disposed on the lower face of the powder supplying/recovering member.

(6) A powder deposition method including:

disposing, in a vacuum container, a drum-like rotating body configured to rotate in a vertical direction;

disposing a deposition source inside the drum-like rotating body;

performing deposition by the deposition source after powder is supplied to an inner wall of the drum-like rotating body in a state where the drum-like rotating body rotates and a bottom portion of a tubular powder supplying/recovering member allowed in an open state;

recovering the powder supplied to the inner wall of the drum-like rotating body through an upper face of the tubular powder supplying/recovering member; and

accumulating the recovered powder in the tubular powder supplying/recovering member by allowing a vicinity of a lower face of the tubular powder supplying/recovering member in a closed state.

What is claimed is:

1. A powder deposition apparatus comprising:
a drum-like rotating body disposed in a vacuum container and configured to rotate in a vertical direction;
a deposition source disposed inside the drum-like rotating body;
a tubular powder supplying/recovering member disposed close to an inner wall of the drum-like rotating body and configured to recover powder coming through an upper face and to supply the powder to the inner wall through a lower face; and
a lid member provided in a vicinity of the lower face of the powder supplying/recovering member and configured to supply the powder to the inner wall through the lower face of the powder supplying/recovering member by being allowed in an open state and to accumulate the powder coming in the powder supplying/recovering member through the upper face by being allowed in a closed state.

2. The powder deposition apparatus according to claim 1,
wherein the lid member supplies the powder to the inner wall under gradual change from the closed state to the open state in a state where the drum-like rotating body rotates at a rate to an extent to which centrifugal force generates such that the powder does not fall off the inner wall.

3. The powder deposition apparatus according to claim 2,
wherein the powder supplying/recovering member is movable between a state where the upper face separates from the inner wall of the drum-like rotating body and a state where the upper face comes into contact with or is close to the inner wall of the drum-like rotating body,
wherein the upper face is allowed in the state where the upper face separates from the inner wall of the drum-like rotating body when the powder is supplied to the inner wall under gradual change from the closed state to the open state of the lid member, and
wherein the upper face is allowed in the state where the upper face comes into contact with or is close to the inner wall of the drum-like rotating body when the powder is recovered from the inner wall.

4. The powder deposition apparatus according to claim 3,
wherein, after supplying the powder to the inner wall of the drum-like rotating body through the lower face of the powder supplying/recovering member in the open state of the lid member while the powder supplying/recovering member recovers the powder from the inner wall of the drum-like rotating body, and the upper face is allowed in the state where the upper face comes into contact with or is close to the inner wall of the drum-like rotating body, the powder is accumulated in the powder supplying/recovering member, and the lid member is allowed in the closed state.

5. The powder deposition apparatus according to claim 4,
wherein a member configured to stir the powder is disposed on the lower face of the powder supplying/recovering member.

6. A powder deposition method comprising:
disposing, in a vacuum container, a drum-like rotating body configured to rotate in a vertical direction;
disposing a deposition source inside the drum-like rotating body;
performing deposition by the deposition source after powder is supplied to an inner wall of the drum-like rotating body in a state where the drum-like rotating body rotates and a bottom portion of a tubular powder supplying/recovering member allowed in an open state;
recovering the powder supplied to the inner wall of the drum-like rotating body through an upper face of the tubular powder supplying/recovering member; and
accumulating the recovered powder in the tubular powder supplying/recovering member by allowing a vicinity of a lower face of the tubular powder supplying/recovering member in a closed state.
